(19) United States
(12) Patent Application Publication
(10) Pub. No.: US 2013/0278723 A1
(43) Pub. Date: Oct. 24, 2013

(54) THREE-DIMENSIONAL MEASUREMENT SYSTEM AND THREE-DIMENSIONAL MEASUREMENT METHOD

(71) Applicant: TEST RESEARCH, INC., Taipei City (TW)

(72) Inventors: Liang-Pin YU, New Taipei City (TW); Don LIN, Taipei City (TW)

(73) Assignee: TEST RESEARCH, INC., Taipei City (TW)

(21) Appl. No.: 13/732,702

(22) Filed: Jan. 2, 2013

(30) Foreign Application Priority Data
Apr. 20, 2012 (TW) 101114217

(51) Int. Cl. G01B 11/25

(52) U.S. Cl. CPC G01B 11/2513
USPC 348/46

(57) ABSTRACT

A three-dimensional measurement system includes a measurement carrier, first and second projection modules, an image-capturing module, and a control unit. The measurement carrier carries a test object on a measurement plane. The first projection module projects a first patterned structure light onto the test object along a first optical axis that forms a first incident angle relative to the measurement plane, and the second projection module projects a second patterned structure light onto the test object along a second optical axis that forms a second incident angle different from the first incident angle. The image-capturing module captures first and second patterned images formed after reflection of the first and second patterned structure lights from the test object. The control unit controls the first and second projection modules, and measures a three-dimensional shape of the test object according to the first and second patterned images.

### RELATED APPLICATIONS

This application claims priority to Taiwan Application Serial Number 101114217, filed Apr. 20, 2012, which is herein incorporated by reference.

### BACKGROUND

1. Technical Field

The invention relates to a three-dimensional measurement system and method thereof. More particularly, the invention relates to an optical configuration within a three-dimensional measurement system.

2. Description of Related Art

With the shrinking of the dimensions of electronic components in recent years, lots of automated high-precision testing equipments have been developed for performing the detections of appearance, circuitry connection and alignment relationship of electronic components. Among the different types of such equipments, the Solder Paste Inspection (SPI) machine has been widely used in production lines for accurate measurements of the printed volume of solder paste on substrates, and has become an elemental instrument for quality control of the manufacturing process of printed circuit board assembly.

One consequence of this has been that technologies related to the field of SPI are improved with time, and an example of this has been the advances so called anti-shadowing technology. The Multi-Frequency Method is a measuring method for detecting a wide range 3D height profile on a substrate. In traditional Multi-Frequency Method, two structure lights with different line pitches are projected onto a test object. Two image sets of phase-shifting information of these two pitches of patterns are collected respectively, and the two sets of phase-shifting information are calculated individually to obtain phase envelope of the two projection pitches.

If the Multi-Frequency Method utilizes patterned structure light (e.g., an equal-spaced-multi-line pattern) with only one pitch, the height of the test object may not be estimated when the height range of the test object exceeds the measurement capability of default range of 2π phase of the equal-spaced-multi-line patterned structure light with the one pitch, the actual phase information then might be phase+2π, phase+4π, phase+6π, . . . . Such a phenomenon is referred to as 2π Ambiguity.

The Multi-Frequency Method is calculated based on a longer equivalent pitch, which is integrated from at least two sets of patterned structure lights with different pitches. The Multi-Frequency Method does not easily encounter the problem of 2π Ambiguity and is suitable for distance estimation of a test object relative to a reference surface.

There are two traditional ways of forming two equal-spaced-multi-line patterned structure lights with different pitches. One involves utilizing different projection magnification ratios, but such an approach may cause two optical paths with unmatched length or may require optical lenses with different focal lengths which will cause an asymmetric optical system configuration. The other way in which two patterned structure lights with different pitches are formed involves utilizing equal-spaced-multi-line patterned films with different pitches (i.e., line pairs per unit length, e.g., lp/mm). However, the selections of the films on the market are limited with only specific numbers of line pairs per unit length, and therefore it will limited the design flexibility for different system requirements.

### SUMMARY

In order to solve the problems of the prior art, a technical aspect of the invention provides a three-dimensional measurement system and a three-dimensional measurement method, which include at least two sets of projection modules. These two projection modules may project patterned structure lights (e.g., an equal-spaced-multi-line pattern) onto a measurement plane from different incident angles. The patterned structure lights formed on the measurement plane may have different projective line periods according to the difference of the incident angles. In an alternative embodiment, optical gratings of these two projection modules may have grating stripes which are non-parallel. Different projective line periods of the patterned structure lights can be formed on the measurement plane by utilizing a tilted angle between two sets of grating stripes. The manner in which stripes with different cycles are generated does not require modifying the projective magnification ratio or the optical configurations. In addition, the disclosure may adopt patterned films (e.g., an equal-spaced-multi-line pattern) with the same pitch (i.e., forming the same pitch), and different projective line periods are achieved by varying the incident angles of the projection modules or rotating the patterned films of the optical gratings.

An aspect of the invention provides a three-dimensional measurement system including a measurement carrier, a first projection module, a second projection module, an image-capturing module and a control unit. The measurement carrier is configured for carrying a test object on a measurement plane. The first projection module is configured for projecting a first patterned structure light (e.g., an equal-spaced-multi-line pattern) onto the test object along a first optical axis. The first optical axis forms a first incident angle relative to the measurement plane. The second projection module is configured for projecting a second patterned structure light (e.g., an equal-spaced-multi-line pattern) onto the test object along a second optical axis. The second optical axis forms a second incident angle relative to the measurement plane. The second incident angle is different from the first incident angle, such that a second projective line period of the second patterned structure light formed on the measurement plane is different from a first projective line period of the first patterned structure light formed on the measurement plane. The image-capturing module is configured for capturing a first patterned image (e.g., an equal-spaced-multi-line pattern), which is formed after reflection of the first patterned structure light from the test object, and a second patterned image (e.g., an equal-spaced-multi-line pattern), which is formed after reflection of the second patterned structure light from the test object. The control unit is configured for controlling the first projection module and the second projection module, and measuring a three-dimensional shape of the test object according to the first patterned image and the second patterned image.

According to an embodiment of the invention, the first projection module includes a first light source and a first optical grating. The first light source generates a first structure light. The first optical grating has a plurality of first stripes spaced apart from each other by a first pitch from for transforming the first structure light into the first patterned structure light with a first equivalent line period. The second projection module includes a second light source and a second optical grating. The second light source generates a second structure light. The second optical grating has a plurality of second stripes spaced apart from each other by a second pitch for transforming the second structure light into the second patterned structure light with a second equivalent line period.

According to an embodiment of the invention, the first pitch of the first optical grating is equal to the second pitch of the second optical grating. The first equivalent line period is equal to the second equivalent line period.

According to an embodiment of the invention, the first projection module further includes an optical grating shifter. The optical grating shifter is utilized to move the first optical grating for forming different phase angles of the first patterned structure light. The image-capturing module further captures a plurality of first patterned images, which are formed after reflection of the first patterned structure light with different phase angles from the test object.

According to an embodiment of the invention, the second projection module further includes an optical grating shifter. The optical grating shifter is utilized to move the second optical grating for forming different phase angles of the second patterned structure light. The image-capturing module further captures a plurality of second patterned images, which are formed after reflection of the second patterned structure light with different phase angles from the test object.

According to an embodiment of the invention, the three-dimensional measurement system further includes a height calculation module for calculating a height of the test object. The height calculation module integrates the first patterned image formed by reflection of the first patterned structure light and the second patterned image formed by reflection of the second patterned structure light for obtaining integrated height information of the test object.

Another aspect of the invention provides a three-dimensional measurement method for measuring a test object on a measurement plane. The three-dimensional measurement method includes steps of generating a first patterned structure light with a first equivalent line period and a second patterned structure light with a second equivalent line period; projecting the first patterned structure light onto the test object on the measurement plane along a first optical axis, in which the first optical axis forms a first incident angle relative to the measurement plane; projecting the second patterned structure light onto the test object on the measurement plane along a second optical axis, wherein the second optical axis forms a second incident angle relative to the second optical axis and the measurement plane, the second incident angle being different from the first incident angle, such that a second projective line period of the second patterned structure light formed on the measurement plane being different from a first projective line period of the first patterned structure light formed on the measurement plane; capturing a plurality of first patterned images using the first patterned structure light with different phase angles, the first patterned images being generated by reflection of the first patterned structure light with the first projective line period from the test object; capturing a plurality of second patterned images using the second patterned structure light with different phase angles, the second patterned images being generated by reflection of the second patterned structure light with the second projective line period from the test object; utilizing the plurality of first patterned images with the first projective line period to obtain first phase information of the test object; utilizing the plurality of second patterned images with the second projective line period to obtain second phase information of the test object; and obtaining integrated height information of the test object according to the first phase information and the second phase information.

According to an embodiment of the invention, the integrated height information is obtained according to a line period difference between the first projective line period and the second projective line period, and a relative difference between the first phase information and the second phase information.

According to an embodiment of the invention, a first optical grating with a first pitch is utilized to form the first equivalent line period of the first patterned structure light. A second optical grating with a second pitch is utilized to form the second equivalent line period of the second patterned structure light. The first pitch is equal to the second pitch. The first equivalent line period is equal to the second equivalent line period.

According to an embodiment of the invention, the three-dimensional measurement method further comprises steps of moving the first optical grating for forming different phase angles of the first patterned structure light, and moving the second optical grating for forming different phase angles of the second patterned structure light.

Another aspect of the invention provides a three-dimensional measurement system including a measurement carrier, a first projection module, a second projection module, an image-capturing module and a control unit. The measurement carrier is configured for carrying a test object on a measurement plane. The first projection module includes a first optical grating. The first optical grating has a plurality of first stripes. The first projection module projects a first patterned structure light onto the test object. The second projection module includes a second optical grating. The second optical grating has a plurality of second stripes. The second projection module projects a second patterned structure light onto the test object. The first stripes of the first optical grating is non-parallel to the second stripes of the second optical grating and a tilted angle being is formed therebetween, such that a second projective line period of the second patterned structure light formed on the measurement plane is different from a first projective line period of the first patterned structure light formed on the measurement plane. The image-capturing module is configured for capturing a first patterned image, which is formed after reflection of the first patterned structure light from the test object, and a second patterned image, which is formed after reflection of the second patterned structure light from the test object. The control unit is configured for controlling the first projection module and the second projection module, and measuring a three-dimensional shape of the test object according to the first patterned image and the second patterned image.

According to an embodiment of the invention, the first projection module further comprises a first light source. The first light source generates a first structure light. The first stripes of the first optical grating are spaced apart from each other by a first pitch for transforming the first structure light into the first patterned structure light with the first equivalent line period. The second projection module further comprises a second light source. The second light source generates a second structure light. The second optical grating has a plurality of second stripes spaced apart from each other by a second pitch for transforming the second structure light into the second patterned structure light with a second equivalent line period.

According to an embodiment of the invention, the first pitch of the first optical grating is equal to the second pitch of the second optical grating. The first equivalent line period is equal to the second equivalent line period.

According to an embodiment of the invention, the first projection module further includes an optical grating shifter. The optical grating shifter is utilized to move the first optical grating for forming different phase angles of the first patterned structure light. The image-capturing module further captures a plurality of first patterned images, which are formed after reflection of the first patterned structure light with different phase angles from the test object.

According to an embodiment of the invention, the second projection module further includes an optical grating shifter. The optical grating shifter is utilized to move the second optical grating for forming different phase angles of the second patterned structure light. The image-capturing module further captures a plurality of second patterned images, which are formed after reflection of the second patterned structure light with different phase angles from the test object.

According to an embodiment of the invention, the three-dimensional measurement system further includes a height calculation module for calculating a height of the test object. The height calculation module integrates the first patterned image formed by reflection of the first patterned structure light and the second patterned image formed by reflection of the second patterned structure light for obtaining integrated height information of the test object.

### BRIEF DESCRIPTION OF THE DRAWINGS

In order to make the foregoing as well as other purposes, features, advantages, and embodiments of the invention more apparent, the accompanying drawings are described as follows:

FIG. 1 is a schematic diagram illustrating a three-dimensional measurement system according to an embodiment of the invention;

FIG. 2 is a schematic diagram illustrating a first patterned structure light and a second patterned structure light projected onto a measurement plane according to the embodiment illustrated in FIG. 1;

FIG. 3 is a schematic diagram illustrating a first optical grating according to the embodiment illustrated in FIG. 1;

FIG. 4 is a schematic diagram illustrating a second optical grating according to the embodiment illustrated in FIG. 1;

FIG. 5 is a flow diagram illustrating a three-dimensional measurement method according to an embodiment of the invention;

FIG. 6 is a schematic diagram illustrating a three-dimensional measurement system according to another embodiment of the invention;

FIG. 7 is a schematic diagram illustrating the first optical grating in this embodiment;

FIG. 8 is a schematic diagram illustrating the second optical grating in this embodiment; and

FIG. 9 is a schematic diagram illustrating the relationship between the first optical grating and the second optical grating in this embodiment.

### DESCRIPTION OF THE EMBODIMENTS

A plurality of embodiments of the invention will be disclosed hereafter with reference to the drawings. For purposes of clear illustration, many details of practical applications will be described in the following disclosure. However, it should be understood that these details of practical applications are not intended to limit the invention. That is, in some embodiments of the invention, these details are not necessary. Furthermore, for purpose of simplifying the drawings, some conventional structures and components in the drawings will be shown schematically.

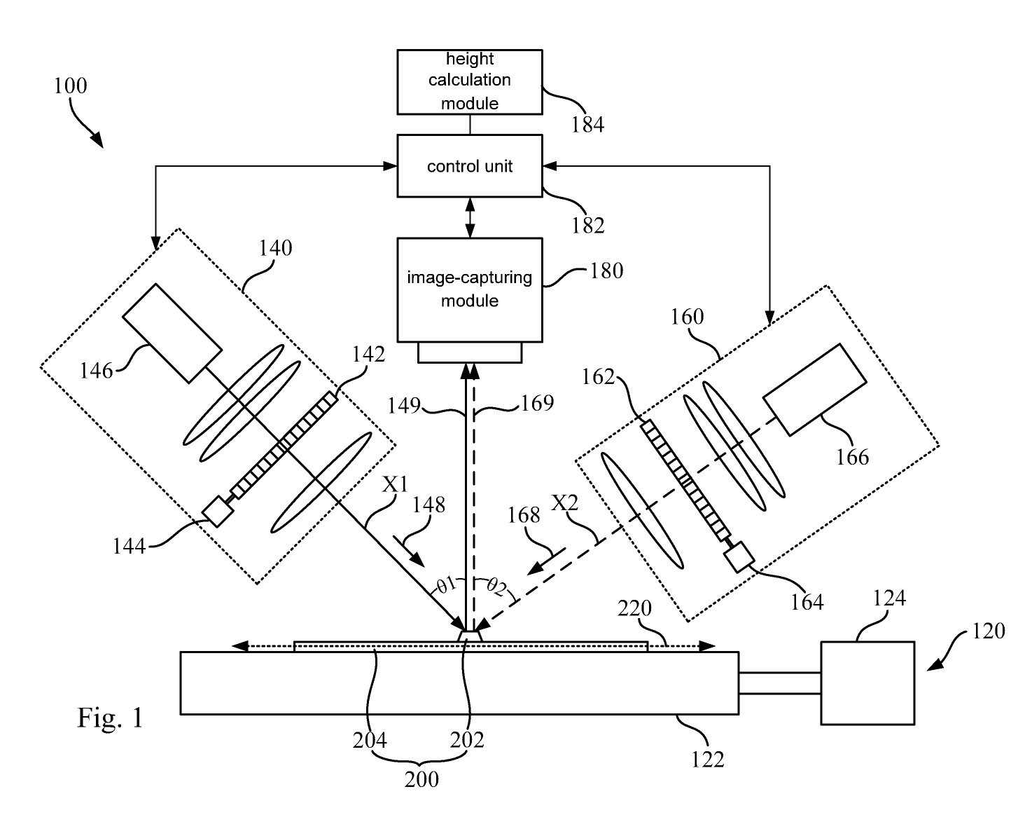

Reference is made to FIG. 1, which is a schematic diagram illustrating a three-dimensional measurement system 100 according to an embodiment of the invention. In this embodiment, the three-dimensional measurement system 100 includes a measurement carrier 120, a first projection module 140, a second projection module 160, an image-capturing module 180, a control unit 182 and a height calculation module 184.

The measurement carrier 120 includes a carrier platform 122 and a moving unit 124. The carrier platform 122 is used for carrying a test object 200. The moving unit 124 is configured for driving the carrier platform 122 to move horizontally, such that the carrier platform 122 may bring the test object 200 to move horizontally on a measurement plane 220.

In this embodiment, the test object 200 may include a substrate 204 and an object 202 located on the substrate 204. In some applications, the object 202 can be solder paste on the substrate 204. The object 202 may also be circuitry or an equivalent electronic component. The three-dimensional measurement system 100 is utilized to measure the three-dimensional shape of the test object 200 including the substrate 204 and any object 202 located on the substrate 204. In the following paragraphs, it will be assumed that the test object 200 includes the substrate 204 and any object 202 located on the substrate 204.

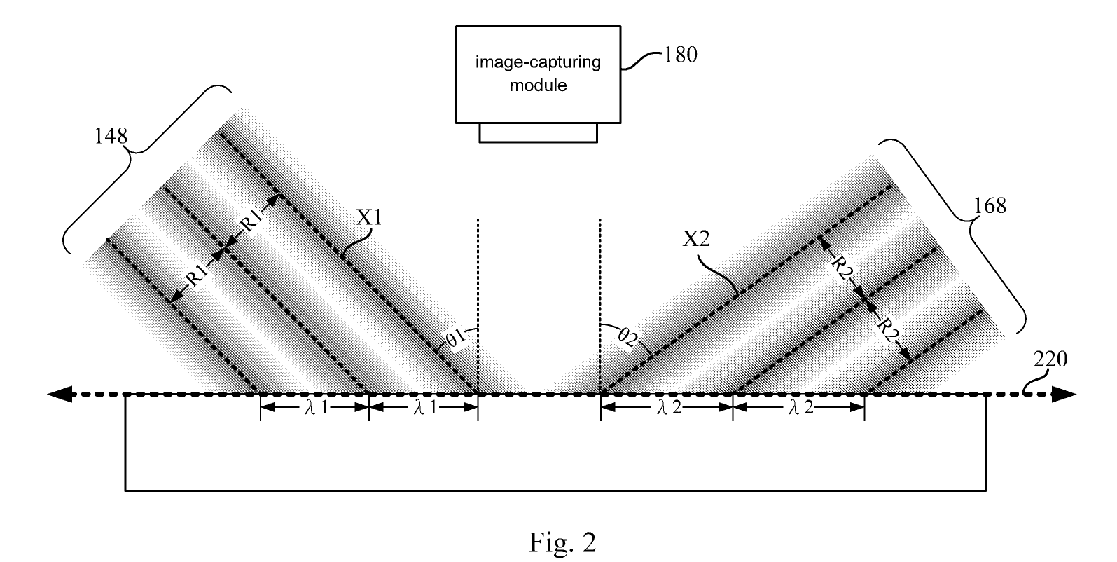

Reference is also made to FIG. 2, which is a schematic diagram illustrating a first patterned structure light 148 and a second patterned structure light 168 projected onto the measurement plane 220 according to the embodiment illustrated in FIG. 1.

The first projection module 140 projects the first patterned structure light 148 toward the test object 200 along a first optical axis X1. The first optical axis X1 forms a first incident angle θ1 relative to the measurement plane 220 (i.e., the first incident angle θ1 is formed between the first optical axis X1 and a vertical axis of the measurement plane 220).

The second projection module 160 is configured for projecting the second patterned structure light 168 onto the test object 200 along a second optical axis X2. The second optical axis X2 forms a second incident angle θ2 relative to the measurement plane 220 (i.e., the second incident angle θ2 is formed between the second optical axis X2 and a vertical axis of the measurement plane 220).

As shown in FIG. 1, the first projection module 140 includes a first optical grating 142, an optical grating shifter 144 and a first light source 146.

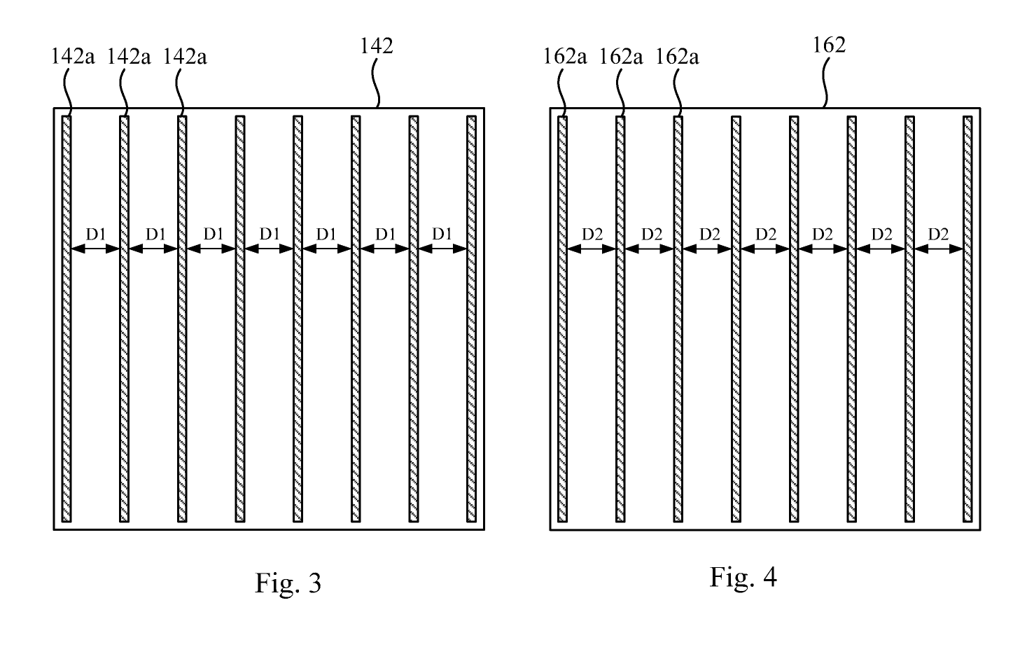

Reference is also made to FIG. 3, which is a schematic diagram illustrating the first optical grating 142 according to the embodiment illustrated in FIG. 1. In this embodiment, the first optical grating 142 is a patterned film with a plurality of first stripes 142a. The first stripes 142a are spaced apart from each other by a first pitch D1 for transforming a first structure light generated by the first light source 146 into the first patterned structure light 148 with a first equivalent line period R1, as shown in FIG. 2.

As shown in FIG. 1, the second projection module 160 includes a second optical grating 162, an optical grating shifter 164 and a second light source 166.

Reference is also made to FIG. 4, which is a schematic diagram illustrating the second optical grating 162 according to the embodiment illustrated in FIG. 1. In this embodiment, the second optical grating 162 is a patterned film with a plurality of second stripes 162a. The second stripes 162a are spaced apart from each other by a second pitch D2 for transforming a second structure light generated by the second light source 166 into the second patterned structure light 168 with a second equivalent line period R2, as shown in FIG. 2.

It is noted that the first optical grating 142 adopted by the first projection module 140 can be substantially the same as the second optical grating 162 adopted by the second projection module 160. In other words, the first pitch D1 of the first optical grating 142 can be equal to the second pitch D2 of the second optical grating 162. Therefore, the first equivalent line period R1 of the first patterned structure light 148 is equal to the second equivalent line period R2 of the second patterned structure light 168.

As shown in FIG. 2, the first incident angle θ1 of the first patterned structure light 148 relative to the measurement plane 220 is different from the second incident angle θ2 of the second patterned structure light 168 relative to the measurement plane 220. That is, the first incident angle θ1 is different from the second incident angle θ2, such that a second projective line period λ2 of the second patterned structure light 168 formed on the measurement plane 220 is different from a first projective line period λ1 of the first patterned structure light 148 formed on the measurement plane 220.

The first projective line period λ1 and the second projective line period λ2 may be expressed as follows:

λ1=R1·cos⁻¹θ1 And λ2=R2·cos⁻¹θ2

In the aforesaid equations, the first equivalent line period R1 is equal to the second equivalent line period R2, while the first incident angle θ1 is different from the second incident angle θ2. Consequently, the first projective line period λ1 is not equal to the second projective line period λ2.

Therefore, the three-dimensional measurement system 100 does not need to change the pitches on the optical grating films. The three-dimensional measurement system 100 may form two sets of patterned structure lights with different projective line periods on the measurement plane 220 by projecting two sets of patterned structure lights along different incident angles onto the measurement plane 220.

In this embodiment, the first projection module 140 further includes the optical grating shifter 146 for shifting the first optical grating 142, such that the first optical grating 142 is moved along a direction perpendicular to the first stripes 142a (i.e., the horizontal direction shown in FIG. 3), so as to form different phase angles of the first patterned structure light 148. The image-capturing module 180 further captures a plurality of first patterned images 149, which are formed after reflection of the first patterned structure light 148 with different phase angles from the test object 200. Based on the phase-shifting measuring method, the first phase information corresponding to the first projective line period λ1 (i.e., the first pitch) is obtained.

The second projection module 160 also includes the optical grating shifter 164 for shifting the second optical grating 162, such that the second optical grating 162 is moved along a direction perpendicular to the second stripes 162a (i.e., the horizontal direction shown in FIG. 4), so as to form different phase angles of the second patterned structure light 168. The image-capturing module 180 further captures a plurality of second patterned images 169, which are formed after reflection of the second patterned structure light 168 with different phase angles from the test object 200. Based on the phase-shifting measuring method, the second phase information corresponding to the second projective line period λ2 (i.e., the second pitch) is obtained.

The height calculation module 184 of the three-dimensional measurement system 100 integrates the first patterned images 149 and the second patterned images 169. Based on the Multi-Frequency Method, calculations are performed with respect to the first patterned images 149 to obtain one set of phase information and with respect to the second patterned images 169 to obtain another set of phase information, and these two sets of phase information are calculated differentially to obtain phase information of the wave envelope thereof, so as to obtain integrated height information of the test object 200. Based on aforesaid measurement of multiple pitches, the 2π Ambiguity problem encountered when utilizing a single pitch can be avoided.

For example, the first projective line period is represented as λ1 and the second projective line period is represented as λ2. The difference between the first and second projective line periods forms the phase of the wave envelope. The equivalent line period of the wave envelope is represented as λp. The equivalent line period λp of the wave envelope satisfies the following relationship:

$$\frac{1}{λ 1} - \frac{1}{λ 2} = \frac{1}{λ p} \\ ⇒ λ p = \frac{λ 1 \cdot λ 2}{λ 2 - λ 1}$$

Therefore, the equivalent line period λp of the wave envelope exceeds either the first projective line period λ1 or the second projective line period λ2. If the first projective line period λ1 and the second projective line period λ2 are relatively short while measuring the test object 200, the height of the test object may fall on several possible locations over adjacent cycles (e.g., −2π, 0, +2π) of the first projective line period λ1 or the second projective line period λ2. Because the equivalent line period λp of the wave envelope is relatively long, the possible location of the height of the test object 200 may not be out of the 2π range of the equivalent line period λp, so as to avoid the 2π Ambiguity problem.

The image-capturing module 180 is configured for capturing the first patterned images 149, which are formed after reflection of the first patterned structure light 148 from the test object 200, and the second patterned images 169, which are formed after reflection of the second patterned structure light 168 from the test object 200. The control unit 182 is configured for controlling the first projection module 140 and the second projection module 160, and measuring a three-dimensional shape of the test object 200 according to the first patterned images 149 and the second patterned images 169.

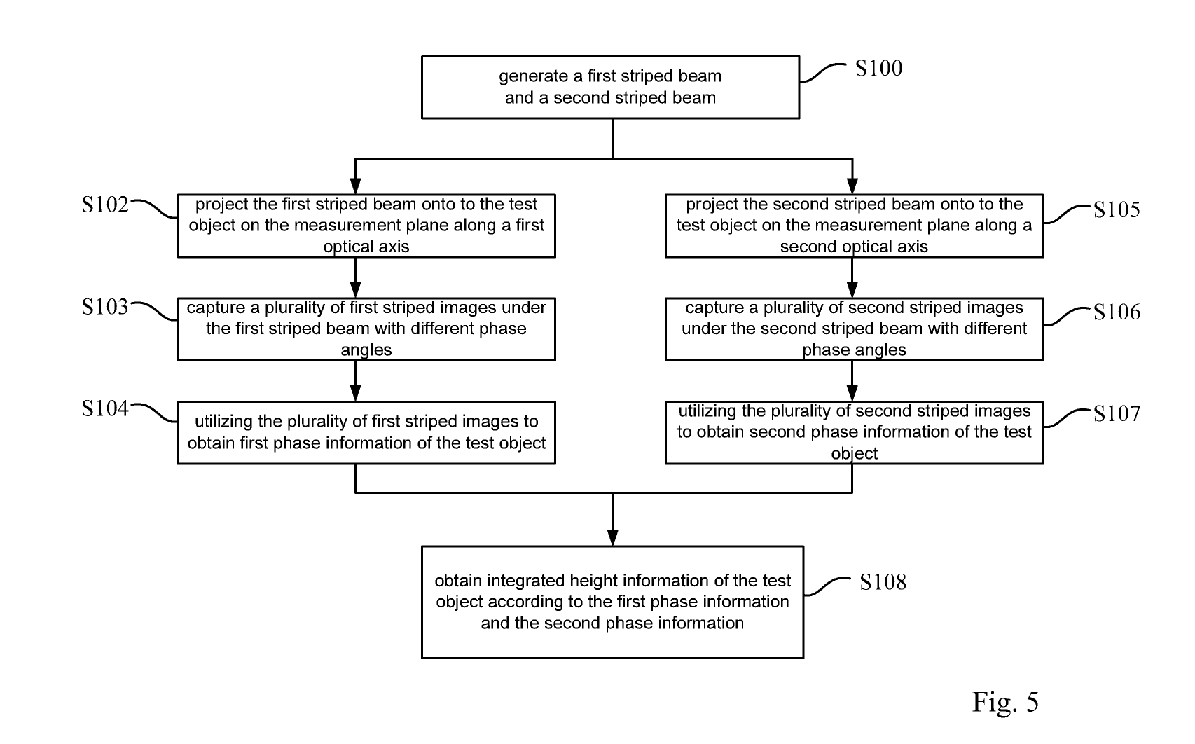

Reference is made to FIG. 5, which is a flow diagram illustrating a three-dimensional measurement method according to an embodiment of the invention. The three-dimensional measurement method may be implemented by the embodiment of the three-dimensional measurement system 100 illustrated in FIG. 1 to FIG. 4 for measuring the test object on the measurement plane.

First, in step S100, a first patterned structure light with a first equivalent line period and a second patterned structure light with a second equivalent line period are generated. In this embodiment, the first equivalent line period (see the first equivalent line period R1 of the first patterned structure light 148 in FIG. 2) can be equal to the second equivalent line period (see the second equivalent line period R2 of the second patterned structure light 168 in FIG. 2).

Next, steps S102, S103 to S104 or steps S105, S106 to S107 are executed in sequence.

In Step S102, the first patterned structure light is projected onto the test object on the measurement plane along a first optical axis. The first optical axis forms a first incident angle relative to the measurement plane.

In Step S103, a plurality of first patterned images are captured using the first patterned structure light with different phase angles. The first patterned images are generated by reflection of the first patterned structure light with the first projective line period from the test object 200.

In Step S104, the plurality of first patterned images with the first projective line period are used to obtain first phase information of the test object according to the phase-shifting method.

In Step S105, the second patterned structure light is projected onto the test object on the measurement plane along a second optical axis. The second optical axis forms a second incident angle relative to the measurement plane. The second incident angle is different from the first incident angle, such that a second projective line period (see λ2 in FIG. 2) of the second patterned structure light formed on the measurement plane is different from a first projective line period (see λ1 in FIG. 2) of the first patterned structure light formed on the measurement plane.

In Step S106, a plurality of second patterned images are captured using the second patterned structure light with different phase angles. The second patterned images are generated by reflection of the second patterned structure light with the second projective line period from the test object 200.

In Step S107, the plurality of second patterned images with the second projective line period are used to obtain second phase information of the test object according to the phase-shifting method.

Finally, in step S108, integrated height information of the test object is calculated and obtained according to the first phase information and the second phase information utilizing the Multi-Frequency Method.

The integrated height information is calculated and obtained according to a line period difference between the first projective line period and the second projective line period, and a relative difference between the first phase information and the second phase information.

Details with respect to the relationship between the optical axis, the incident angle and the projective line period in the aforesaid method can be known by referring to the aforesaid embodiment described with reference to FIG. 1 to FIG. 4 and will not be repeated.

In the aforesaid embodiments, the three-dimensional measurement system utilizes different incident angles to form different projective line periods on the measurement plane, but the invention is not limited thereto.

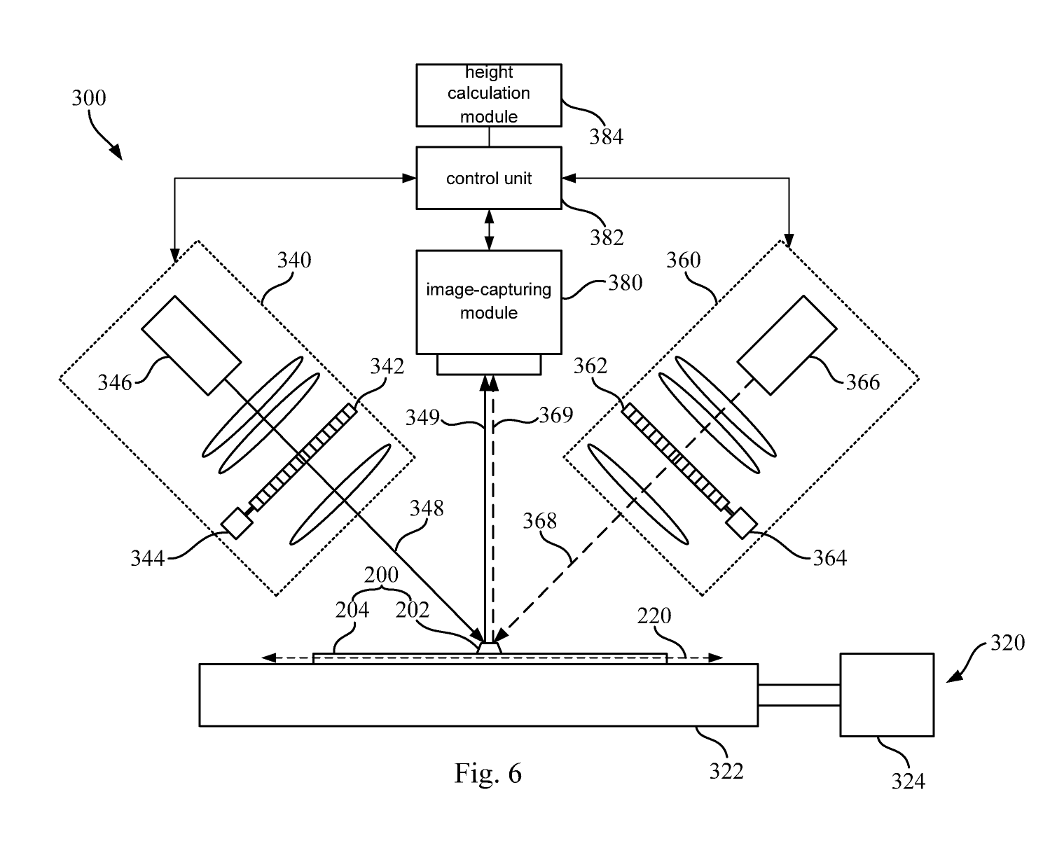

Reference is made to FIG. 6, which is a schematic diagram illustrating a three-dimensional measurement system 300 according to another embodiment of the invention. As shown in FIG. 6, the three-dimensional measurement system 300 includes a measurement carrier 320, a first projection module 340, a second projection module 360, an image-capturing module 380, a control unit 382 and a height calculation module 384.

The first projection module 340 includes a first optical grating 342. The second projection module 360 includes a second optical grating 362.

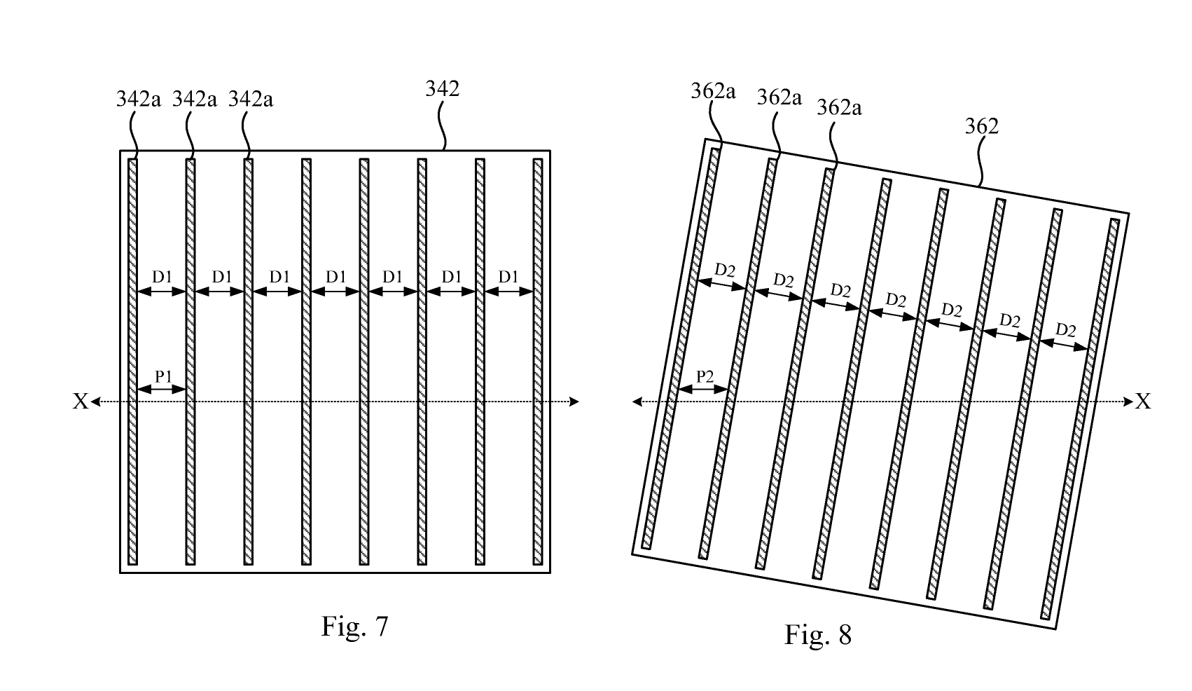

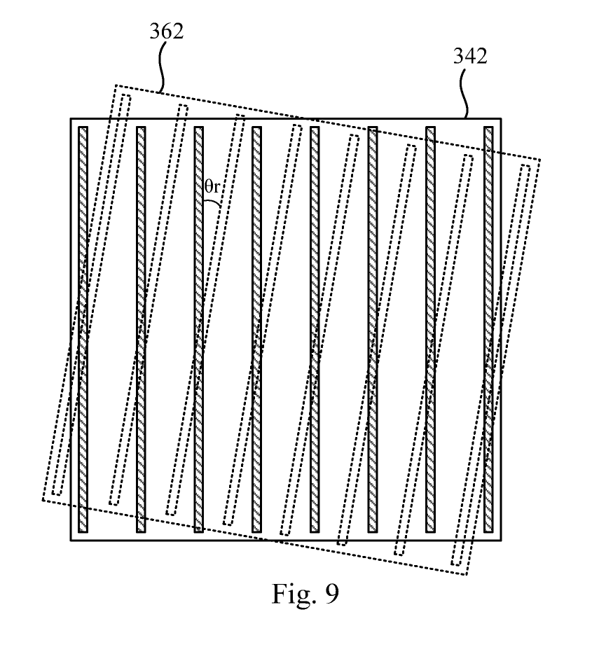

Reference is further made to FIG. 7, FIG. 8 and FIG. 9. FIG. 7 is a schematic diagram illustrating the first optical grating 342 in this embodiment. FIG. 8 is a schematic diagram illustrating the second optical grating 362 in this embodiment. FIG. 9 is a schematic diagram illustrating the relationship between the first optical grating 342 and the second optical grating 362 in this embodiment.

As shown in FIG. 7, the first optical grating 342 has a plurality of stripes 342a. The stripes 342a are spaced apart from each other by a first pitch D1. The first optical grating 342 is configured for transforming a first structure light generated by a first light source 346 into the first patterned structure light 348 with a first equivalent line period.

As shown in FIG. 8, the second optical grating 362 has a plurality of stripes 362a. The stripes 362a are spaced apart from each other by a second pitch D2. The second optical grating 362 is configured for transforming a second structure light generated by a second light source 366 into the second patterned structure light 368 with a second equivalent line period.

In this embodiment, the first pitch D1 of the first optical grating 342 is equal to the second pitch D2 of the second optical grating 362.

As shown in FIG. 9, the first stripes 342a of the first optical grating 342 are non-parallel to the second stripes 362a of the second optical grating 362 and a tilted angle θr is formed therebetween, such that a horizontal projective interval (indicated as the projective interval P1 along the X-axis in FIG. 7) of the first stripes 342a on the measurement plane 220 is different from a horizontal projective interval (indicated as the projective interval P2 along the X-axis in FIG. 8) of the second stripes 362a on the measurement plane 220. Therefore, a second projective line period of the second patterned structure light 368 formed on the measurement plane 220 is different from a first projective line period of the first patterned structure light 348 formed on the measurement plane 220.

The tilted angle θr between the first optical grating 342 and the second optical grating 362 can be achieved by rotating at least one of the optical grating films, or by forming two sets of stripes with the tilted angle θr on the optical grating films during the manufacturing process of the optical grating films.

Therefore, the three-dimensional measurement system 300 does not need to change the pitches on the optical grating films. The three-dimensional measurement system 300 may form the tilted angle θr between two sets of the grating stripes within two projection modules, so as to form two sets of patterned structure lights with different projective line periods on the measurement plane.

Details with respect to other components and operations within the three-dimensional measurement system 300 can be known by referring to the aforesaid embodiment of the three-dimensional measurement system 100 described with reference to FIG. 1 to FIG. 4 and will not be repeated.

In summary, this disclosure provides a three-dimensional measurement system and a three-dimensional measurement method, which include at least two sets of projection modules. These two projection modules may project patterned structure lights onto a measurement plane from different incident angles. The patterned structure lights formed on the measurement plane may have different projective line periods according to the difference of the incident angles. In an alternative embodiment, optical gratings of these two projection modules may have grating stripes which are non-parallel. Different projective line periods of the patterned structure lights can be formed on the measurement plane by utilizing a tilted angle between two sets of grating stripes. The manner in which stripes with different cycles are generated does not require modifying the projective magnification ratio or the optical configurations. In addition, the disclosure may adopt patterned films with the same pitch (i.e., forming the same pitch), and different projective line periods are achieved by varying the incident angles of the projection modules or rotating the patterned films of the optical gratings.

Although the invention has been disclosed with reference to the above embodiments, these embodiments are not intended to limit the invention. It will be apparent to those of skill in the art that various modifications and variations can be made without departing from the spirit and scope of the invention. Thus, the scope of the invention should be defined by the appended claims.

What is claimed is:

1. A three-dimensional measurement system, comprising:
a measurement carrier for carrying a test object on a measurement plane;
a first projection module for projecting a first patterned structure light onto the test object along a first optical axis, wherein the first optical axis forms a first incident angle relative to the measurement plane;
a second projection module for projecting a second patterned structure light onto the test object along a second optical axis, wherein the second optical axis forms a second incident angle relative to the measurement plane, the second incident angle being different from the first incident angle, such that a second projective line period of the second patterned structure light formed on the measurement plane is different from a first projective line period of the first patterned structure light formed on the measurement plane;
an image-capturing module for capturing a first patterned image, which is formed after reflection of the first patterned structure light from the test object, and a second patterned image, which is formed after reflection of the second patterned structure light from the test object; and
a control unit for controlling the first projection module and the second projection module, and measuring a three-dimensional shape of the test object according to the first patterned image and the second patterned image.

2. The three-dimensional measurement system of claim 1, wherein the first projection module comprises a first light source and a first optical grating, the first light source generates a first structure light, the first optical grating has a plurality of first stripes spaced apart from each other by a first pitch for transforming the first structure light into the first patterned structure light with a first equivalent line period, the second projection module comprises a second light source and a second optical grating, the second light source generates a second structure light, and the second optical grating has a plurality of second stripes spaced apart from each other by a second pitch for transforming the second structure light into the second patterned structure light with a second equivalent line period.

3. The three-dimensional measurement system of claim 2, wherein the first pitch of the first optical grating is equal to the second pitch of the second optical grating, and the first equivalent line period is equal to the second equivalent line period.

4. The three-dimensional measurement system of claim 2, wherein the first projection module further comprises an optical grating shifter, the optical grating shifter is utilized to move the first optical grating for forming different phase angles of the first patterned structure light, and the image-capturing module further captures a plurality of first patterned images, which are formed after reflection of the first patterned structure light with different phase angles from the test object.

5. The three-dimensional measurement system of claim 2, wherein the second projection module further comprises an optical grating shifter, the optical grating shifter is utilized to move the second optical grating for forming different phase angles of the second patterned structure light, and the image-capturing module further captures a plurality of second patterned images, which are formed after reflection of the second patterned structure light with different phase angles from the test object.

6. The three-dimensional measurement system of claim 1, further comprising a height calculation module for calculating a height of the test object, wherein the height calculation module integrates the first patterned image formed by reflection of the first patterned structure light and the second patterned image formed by reflection of the second patterned structure light for obtaining integrated height information of the test object.

7. A three-dimensional measurement method, for measuring a test object on a measurement plane, the three-dimensional measurement method comprising steps of:
generating a first patterned structure light with a first equivalent line period and a second patterned structure light with a second equivalent line period;
projecting the first patterned structure light onto the test object on the measurement plane along a first optical axis, wherein the first optical axis forms a first incident angle relative to the measurement plane;
projecting the second patterned structure light onto the test object on the measurement plane along a second optical axis, wherein the second optical axis forms a second incident angle relative to the measurement plane, the second incident angle being different from the first incident angle, such that a second projective line period of the second patterned structure light formed on the measurement plane is different from a first projective line period of the first patterned structure light formed on the measurement plane;
capturing a plurality of first patterned images using the first patterned structure light with different phase angles, the first patterned images being generated by reflection of the first patterned structure light with the first projective line period from the test object;
capturing a plurality of second patterned images using the second patterned structure light with different phase angles, the second patterned images being generated by reflection of the second patterned structure light with the second projective line period from the test object;
utilizing the plurality of first patterned images with the first projective line period to obtain first phase information of the test object;
utilizing the plurality of second patterned images with the second projective line period to obtain second phase information of the test object; and
obtaining integrated height information of the test object according to the first phase information and the second phase information.

8. The three-dimensional measurement method of claim 7, wherein the integrated height information is obtained according to a line period difference between the first projective line period and the second projective line period, and a relative difference between the first phase information and the second phase information.

9. The three-dimensional measurement method of claim 7, wherein a first optical grating with a first pitch is utilized to form the first equivalent line period of the first patterned structure light, a second optical grating with a second pitch is utilized to form the second equivalent line period of the second patterned structure light, the first pitch is equal to the second pitch, and the first equivalent line period is equal to the second equivalent line period.

10. The three-dimensional measurement method of claim 9, further comprising steps of:
moving the first optical grating for forming different phase angles of the first patterned structure light; and
moving the second optical grating for forming different phase angles of the second patterned structure light.

11. A three-dimensional measurement system, comprising:
a measurement carrier for carrying a test object on a measurement plane;
a first projection module comprising a first optical grating, the first optical grating having a plurality of first stripes, the first projection module projecting a first patterned structure light onto the test object;
a second projection module comprising a second optical grating, the second optical grating having a plurality of second stripes, the second projection module projecting a second patterned structure light onto the test object, the first stripes of the first optical grating being non-parallel to the second stripes of the second optical grating and a tilted angle being formed therebetween, such that a second projective line period of the second patterned structure light formed on the measurement plane is different from a first projective line period of the first patterned structure light formed on the measurement plane;
an image-capturing module for capturing a first patterned image, which is formed after reflection of the first patterned structure light from the test object, and a second patterned image, which is formed after reflection of the second patterned structure light from the test object; and
a control unit for controlling the first projection module and the second projection module, and measuring a three-dimensional shape of the test object according to the first patterned image and the second patterned image.

12. The three-dimensional measurement system of claim 1, wherein the first projection module further comprises a first light source, the first light source generates a first structure light, the first stripes of the first optical grating are spaced apart from each other by a first pitch for transforming the first structure light into the first patterned structure light with the first equivalent line period, the second projection module further comprises a second light source, the second light source generates a second structure light, and the second optical grating has a plurality of second stripes spaced apart from each other by a second pitch for transforming the second structure light into the second patterned structure light with a second equivalent line period.

13. The three-dimensional measurement system of claim 12, wherein the first pitch of the first optical grating is equal to the second pitch of the second optical grating, and the first equivalent line period is equal to the second equivalent line period.

14. The three-dimensional measurement system of claim 11, wherein the first projection module further comprises an optical grating shifter, the optical grating shifter is utilized to move the first optical grating for forming different phase angles of the first patterned structure light, and the image-capturing module further captures a plurality of first patterned images, which are formed after reflection of the first patterned structure light with different phase angles from the test object.

15. The three-dimensional measurement system of claim 11, wherein the second projection module further comprises an optical grating shifter, the optical grating shifter is utilized to move the second optical grating for forming different phase angles of the second patterned structure light, and the image-capturing module further captures a plurality of second patterned images, which are formed after reflection of the second patterned structure light with different phase angles from the test object.

16. The three-dimensional measurement system of claim 11, further comprising a height calculation module for calculating a height of the test object, wherein the height calculation module integrates the first patterned image formed by reflection of the first patterned structure light and the second patterned image formed by reflection of the second patterned structure light for obtaining integrated height information of the test object.
